(19) United States
(12) Patent Application Publication
(10) Pub. No.: US 2008/0047075 A1
(43) Pub. Date: Feb. 28, 2008

(54) POSITIONING STRUCTURE FOR A SLIDING MAGNETIC SHEATH OF A SCREWDRIVER

(76) Inventor: Wun-Hai CHANG, Taiping City (TW)

Correspondence Address: EGBERT LAW OFFICES, 412 MAIN STREET, 7TH FLOOR, HOUSTON, TX, 77002, US

(21) Appl. No.: 11/467,767

(22) Filed: Aug. 28, 2006

(51) Int. Cl. B25F 1/00

(52) U.S. Cl. 7/170

(57) ABSTRACT

The present invention provides a positioning structure for a sliding magnetic sheath of a screwdriver. The tube-shape body is placed over the outer edge of the screwdriver head, and one end of the tube-shape body has a magnetic body. There is a block component placed inside the sheathing hole of the tube-shape body, and the block component includes at least a protruding block and an elastic retractor. The protruding block can be placed against the blocking edge inside the tube-shape body. A tapered indent ring is added on the end of screwdriver head near the functional end, and a tapered slot can be placed near the functional end of the tapered indent ring for the elastic retractor of the block component to insert. The sliding sheath in the present invention can be made in a simpler process, with less cost, and more flexibility.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a structure of a screwdriver, and more particularly to a structure with sliding magnetic sheath.

2. Description of Related Art Including Information Disclosed Under 37 CFR 1.97 and 37 CFR 1.98.

When a user places the head of conventional screwdriver, such as flat screwdriver or a Philips screwdriver, into the grooves of the screw, the screw sometimes falls off the screwdriver because of the loose connection. This problem affects how well the screwdriver works. In a magnetic design, the magnetic effect is applied only to the head of screwdriver, which provides weak magnetic force that does not last long; therefore, the magnetic effect does not solve the problem.

For this reason, screwdriver with magnetic sheath was developed to address the problem of the loose connection to the screw. This prior art structure is shown in FIG. 1. A slot 11 is placed on the screwdriver head 10, and an edge 22 is placed over the sheathing hole 21 of the magnetic sheath 20. The sheath 20 can slide over the slot 11. The magnetic sheath 20 has the ability to slide, but this conventional structure still has problems.

First, the sliding distance of the sheath 20 is determined by the axial length of the slot 11 placed on the screwdriver head 10. In terms of a concrete surface, because the screwdriver head 10 is metal, it must be achieved through the technique of lathe cutting to form the slot 11. The width of the slot 11 made by this process is quite limited. In comparison, the regular width of a knife is only 3-4 mm. The basic sliding distance of the magnetic sheath 20 is about 15 mm, so multiple processes are required to achieve this result. It obviously is not effective, producing such problems as high costs and not being preferable for the industry.

Based on the reason mentioned above, the slidable distance for the magnetic sheath 20 is quite limited, and the maximum movable distance is usually 1-2 cm at the most. Therefore, the magnetic sheath 20 is limited to the end section of the screwdriver head 10. During the operational process and when the screwdriver head must be inserted into a small crack or hole, the screwdriver would not work because of blockage by the magnetic sheath. Furthermore, the function of the screwdriver head is further affected, being one specific disadvantage of the prior art.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention provides a wireless tire pressure and tire temperature detecting system, and it primarily uses a wireless monitoring and transmission device with centrifugal switch. With this invention, when the tire rotational speed (which is car speed) of the car reaches a certain speed, it turns on the centrifugal switch 22. The centrifugal switch 22 is used to turn on the entire wireless monitoring and transmission device to detect, process signals, and transmit. In other words, the wireless monitoring and transmission device is not working, until the tire rotational speed (car speed) of the car reaches a certain speed before it is initiated and caused to consume power. Compared to the conventional structure, the present invention saves more power than the conventional structure, which extends the shelf life of the wireless tire pressure and temperature detecting system as well as time involved to change the battery, which is practical and convenient.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the assembled sectional view of the conventional structure.

FIG. 2 shows the exploded perspective view of the preferred embodiment of the sliding magnetic sheath with screwdriver disclosed in the present invention.

FIG. 3 shows the exploded perspective view of the preferred embodiment of the sliding magnetic sheath of the present invention.

FIG. 4 shows the assembled sectional view of the preferred embodiment of the sliding magnetic sheath of the present invention.

FIG. 5 shows a sectional view of one operation of the sliding magnetic sheath of the present invention.

FIG. 6 shows another sectional view of the another operation of the sliding magnetic sheath of the present invention.

FIG. 7 shows a perspective view of the operation of the sliding magnetic sheath that can slide freely on the screwdriver head.

FIG. 8 shows an enlarged sectional view of the combination of the tube-shaped body and the magnetic body of the present invention.

FIG. 9 shows an exploded perspective view of another embodiment of the block component of the present invention.

FIG. 10 shows the assembled sectional view of the structure disclosed in the FIG. 9.

FIG. 11 shows the assembled sectional view of another embodiment of the sliding magnetic sheath structure of the present invention.

FIG. 12 shows the exploded sectional view disclosed in FIG. 11.

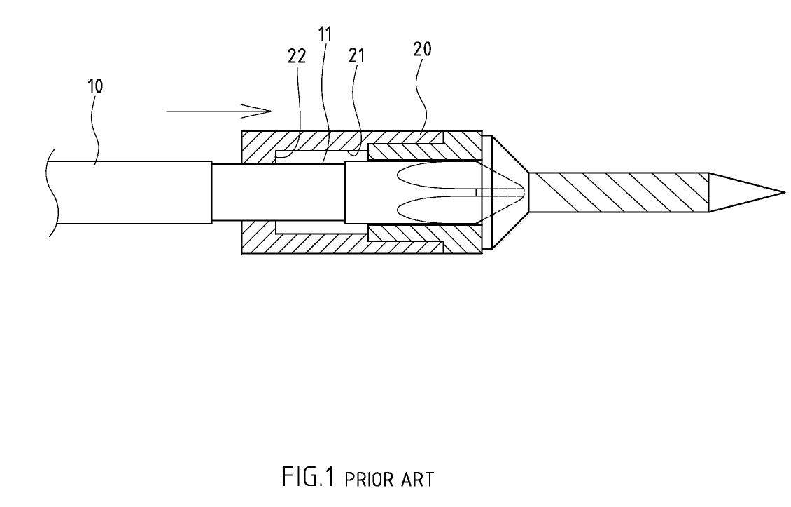

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

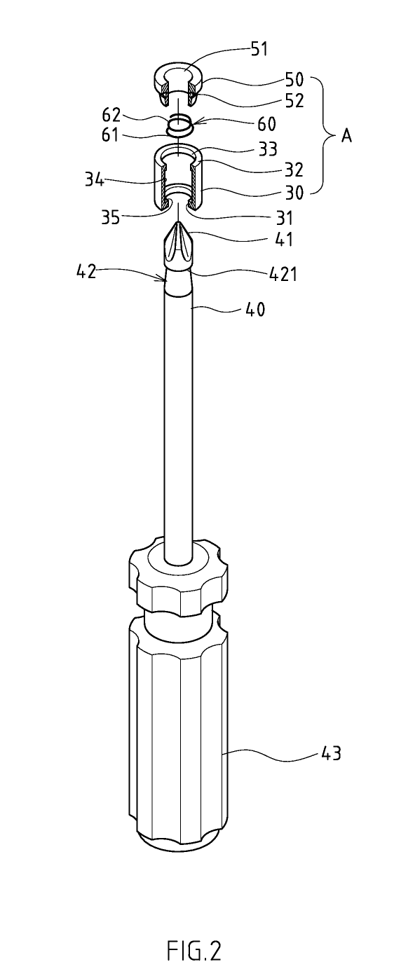

As shown in FIGS. 2-5, a positioning structure for a sliding magnetic sheath of a screwdriver is embodied for the present invention. This embodiment is for description only and is not intended to affect the scope of the patent.

The sliding magnetic sheath includes a tube-shaped body 30, which has a sheathing hole 31 placed on the outside of the screwdriver head 40 for sliding. The tip 32 of the tube-shaped body 30 has a connecting part 33 for a magnetic body. A connecting space 34 is formed inside the sheathing hole 31 of the tube-shape body 30, and the connecting space 34 has a blocking edge 35.

A magnetic body 50 is positioned on the connecting part 33 for the magnetic body of the tube-shaped body 30. A through hole 51 has a through hole 51 in the center of the magnetic body 50 to be placed over the outer side of the screwdriver head 40.

A block component 60 is placed in the connecting space 34 formed inside the sheathing hole 31 of the tube-shaped body 30. The block component 60 includes at least a protruding block 61 and an elastic retractor 62. The protruding block 61 can be placed against the blocking edge 35 for the connecting space 34 of the tube-shape body 30.

The screwdriver head 40 has a tapered indent ring 42 placed near its functional end 41, and the end of the tapered indent ring 42 near functional end 41 is a tapered slot 42. The tapered slot 421 can be used for the elastic retractor 62 of the block component 60 to insert.

The connecting part 33 for the magnetic body placed at the tip of the tube-shaped body 30 can be a ring with an inner protruding edge. The end that corresponds to the magnetic body has a positioning slot 52, and by so doing the tube-shaped body 30 is positioned with the magnetic body 50.

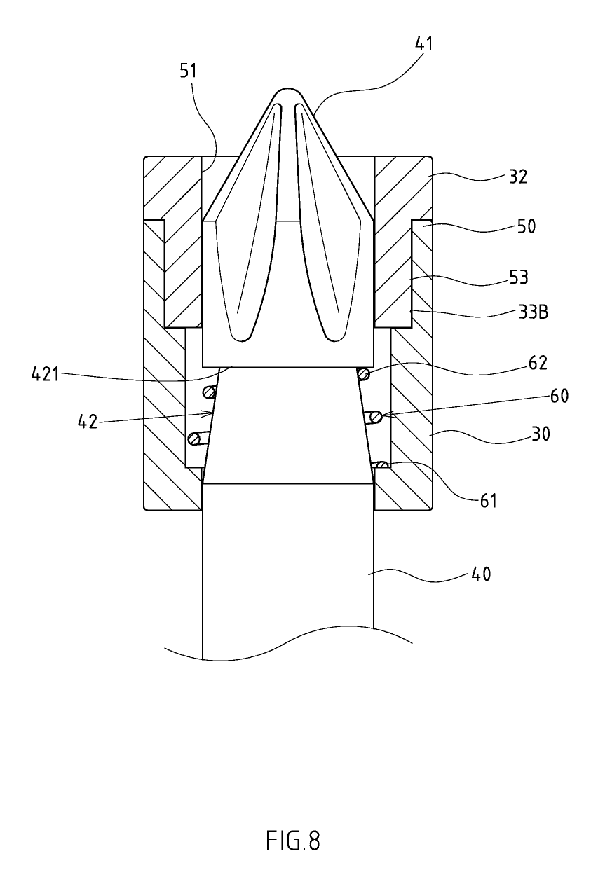

As shown in FIG. 8, the connecting part 33B of the magnetic body for the tip 32 of the tube-shaped body 30 can be an expanded slot. The end that corresponds to the magnetic body 50 has a protruding edge 53, and the space between the protruding edge 53 and the connecting part of the magnetic body can be connected by glue. By so doing, the tube-shaped body 30 and the magnetic body 50 can be positioned with glue.

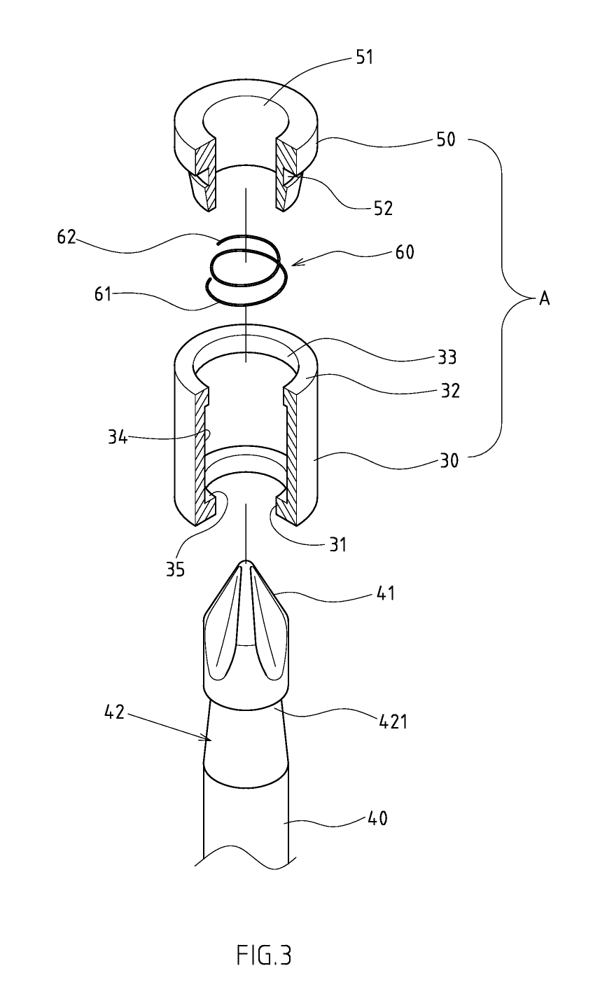

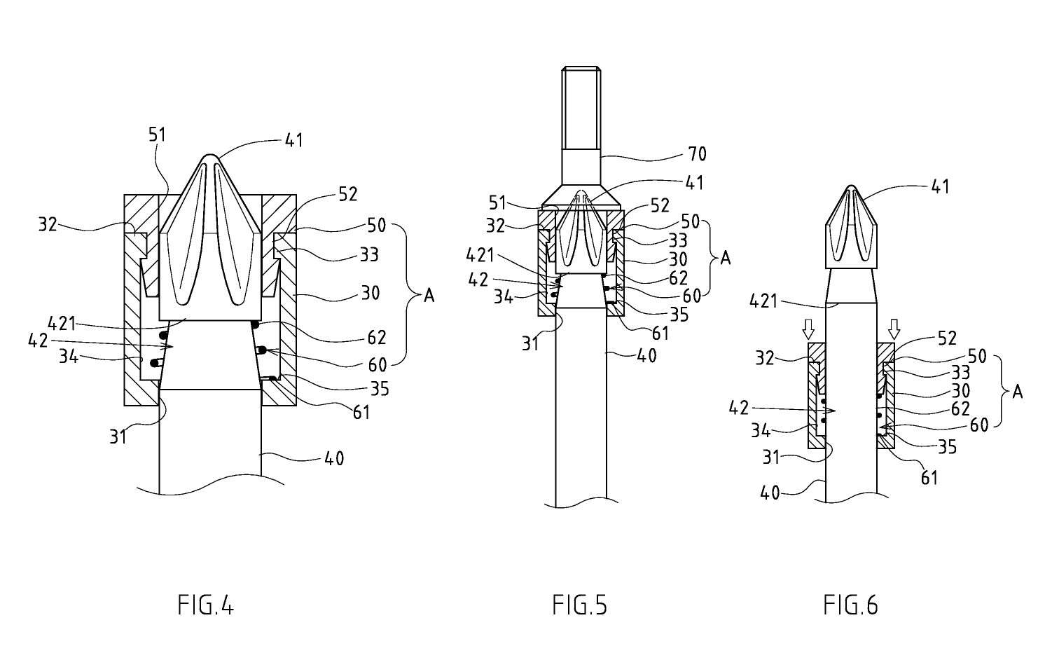

The block component 60 can be a tapered spring, as shown in FIGS. 3-4. A protruding block 61 mentioned above can be made by one end of the expanded tapered end, and an elastic retractor 62 mentioned above is formed by the retracted tapered end.

Through the above structure, the operation of the present invention is explained with the previously discussed embodiment as a representative example.

As shown in FIG. 4, the assembly of the sliding magnetic sheath of the present invention involves inserting the block component 60 inside the connecting space 34 of the tube-shaped body 30. The magnetic body 50 and the tube-shaped body 30 are connected so that the positioning slot 52 can be connected to the connecting part 33 of the magnetic body of the tube-shaped body 30. Meanwhile, the block component 60 is limited in the connecting space 34 of the tube-shaped body 30. Next, the tube-shaped body 30 can be connected to the screwdriver head 40 using the sheathing hole 31 through the functional end 41. During this process, the block component 60 is also connected to the functional end 41 of the screwdriver head 40. When the connecting space 34 of the tube-shaped body 30 corresponds to the tapered indent ring 42 of the screwdriver head 40, the elastic retractor 62 of the block component 60 can be placed against the tapered retracted part 421 of the tapered indent ring 42. The protruding block 61 of the block component 60 can be placed against the blocking edge 35 of the tube-shape body 30, and, by so doing, the sliding magnetic sheath A is made. An elastic blocking effect is created when it is moving toward the functional end 41 of the screwdriver head 40, unless the sliding magnetic sheath A is pulled forcefully, which damages the block component 60. Thus, the sliding magnetic sheath A achieves the limiting effect of keeping it from sliding off. As shown in FIG. 4, the block component 60 of the tapered spring shown in the figure where the block component 60 is still not pressed. Therefore, the sliding magnetic sheath A can still be pulled for a distance toward the direction of the functional end 41 of the screwdriver head 40 until the block component 60 is pressed to the flat condition.

As shown in FIG. 5, when the sliding magnetic sheath A is slid to the functional end 41 of the screwdriver head 40, the magnetic body 50 can be used to attach to the bolt 70 to keep the bolt 70 from falling off.

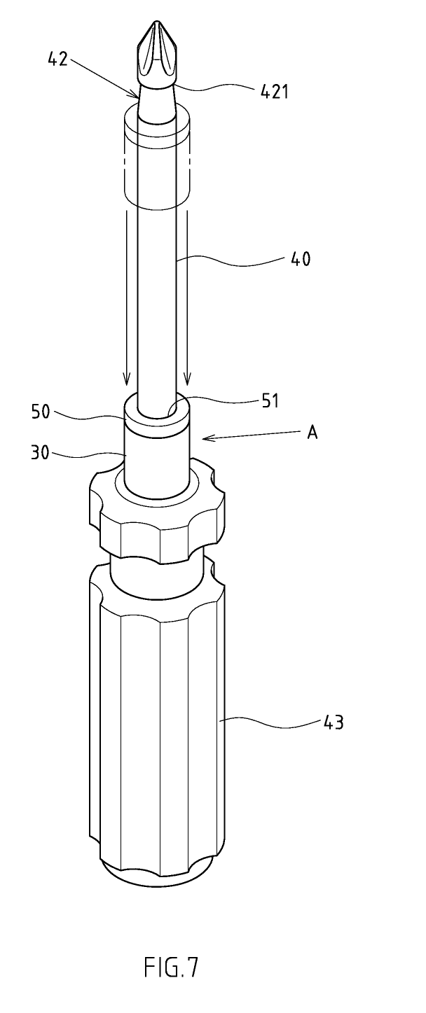

As shown in FIG. 6, when the sliding magnetic sheath A is not used, the user can slide the sliding magnetic sheath A toward the screwdriver head 40 near the screwdriver's handle, as shown in FIG. 7. During this pulling process, the elastic retractor 62 of the block component 60 expands and slides toward the other unretracted section along with the tapered indent ring 42.

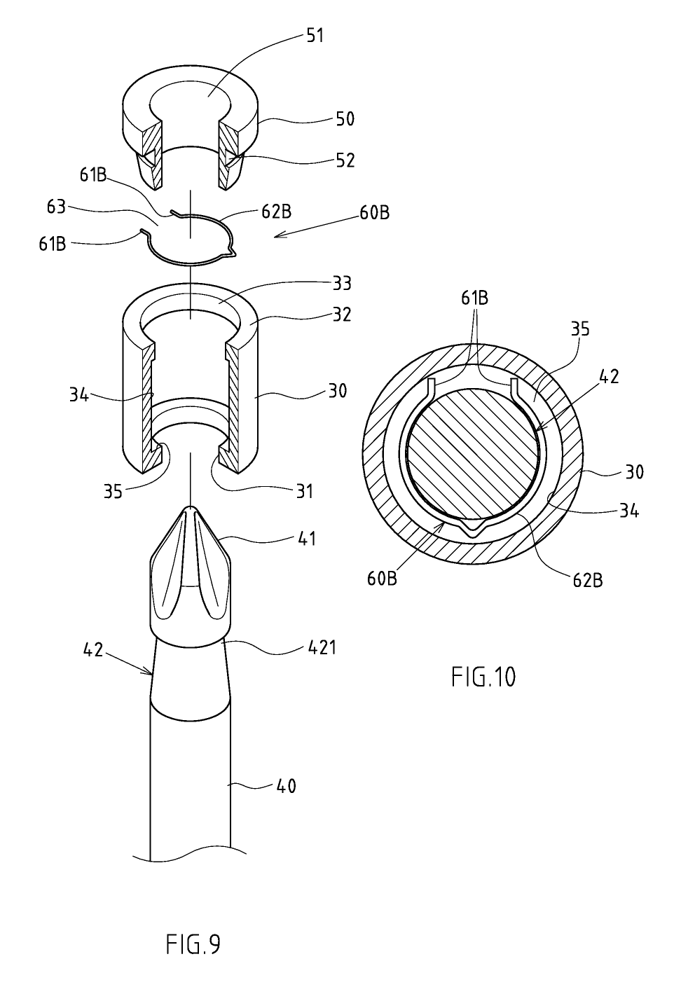

As shown in FIGS. 9-10, a block component 60B is an elastic C-shaped ring, and the opening end 63 of the C-shaped ring has a protruding section. The protruding block 61B mentioned above can be formed by its protruding section, and the elastic retractor 62B mentioned above can be formed by its C-shaped ring. For this embodiment, the elastic retractor 62V can be placed against the retracted slot 421 of the tapered indent ring 42. It's protruding block 61B can be placed against the blocking edge 35 of the tube-shaped body 30.

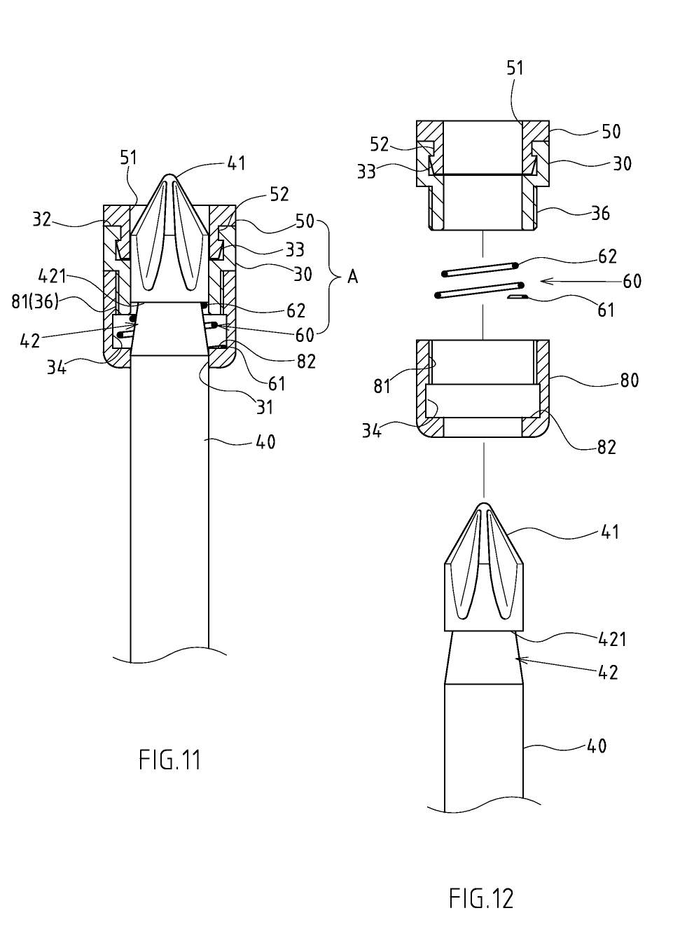

As shown in FIGS. 11-12, there is another embodiment of the present invention. The difference between this embodiment from the previous one is that a removable cover 80 is added to one end of the tube-shaped body 30. The method is to add a screw section 36 on the end of the tube-shaped body 30. The removable cover 80 can be made into a ring, and the end that has a screw part 81 can be connected to the screw section 36 of the tube-shaped body 30. An inner part of the other end of the removable cover 80 has a blocking edge 82. So that when the block component 60 is placed in the connecting space 34 of the tube-shaped body 30, the protruding block 61 can be placed against the blocking edge 82 of the removable cover 80. This embodiment uses the feature that removable cover 80 and tube-shaped body 30 can be separated (as shown in FIG. 12), so that the block component 60 that can be taken off or be replaced, which is more flexible and convenient.

I claim:

1. A positioning structure for a sliding magnetic sheath of a screwdriver, said positioning structure for said sliding magnetic sheath comprising:
a tube-shape body having a sheathing hole placed on an outside of a screwdriver head and tip with a connecting part, said sheathing hole having a connecting space formed inside said sheathing hole, said connecting space having a blocking edge;
a magnetic body being positioned on said connecting part of said tube-shape body, and having a through hole with a second through hole in a center of said magnetic body placed over an outer side of the screwdriver head; and
a block component, being placed in said connecting space formed inside said sheathing hole of said tube-shape body, said block component being comprised of at least a protruding block and an elastic retractor, said protruding block being placed against said blocking edge, wherein the screwdriver head has a tapered indent ring placed near a functional end thereof, wherein an end of the tapered indent ring near functional end is a tapered slot, and wherein the tapered slot is an elastic retractor of the block component to insert.

2. The structure defined in claim 1, wherein said connecting part for said magnetic body is a ring with an inner protruding edge, having an end corresponding to said magnetic body, said end having a positioning slot, said tube-shape body being positioned by said magnetic body.

3. The structure defined in claim 1, wherein said connecting part of said magnetic body is an expanded slot, having an end corresponding to magnetic body, said end having a protruding edge, wherein space between said protruding edge and said connecting part is connected by glue, said tube-shape body and said magnetic body being positioned with glue.

4. The structure defined in claim 1, wherein said block component is a tapered spring, said protruding block being formed by one end of an expanded tapered end, said elastic retractor being formed by a retracted tapered end.

5. The structure defined in claim 1, wherein said block component is comprised of an elastic C-shaped ring, said elastic C-shaped ring having an opening with a protruding section, said protruding block being formed by said protruding section, said elastic retractor being formed by the C-shaped ring.

6. A positioning structure for a sliding magnetic sheath of a screwdriver, said positioning structure for said sliding magnetic sheath comprising:
a tube-shape body having a sheathing hole placed on an outside of a screwdriver head and a tip with a connecting part, said sheathing hole forming a connecting space inside said sheathing hole, an end of said tube-shape body having a screw thread section;
a removable cover, being ring like and having one end with a screw connection screwed to said screw thread section on said tube-shape body, another end of said removable cover having a blocking edge; and
a block component, being placed in said connecting space formed inside said sheathing hole, said block component being comprised of at least a protruding block and an elastic retractor, said protruding block being placed against said blocking edge for said removable cover, wherein the screwdriver head has a tapered indent ring placed near a functional end thereof, wherein an end of the tapered indent ring near said functional end is a tapered slot, said tapered slot forming said elastic retractor of said block component to insert.

7. The structure defined in claim 6, wherein said connecting part for said magnetic body is a ring with an inner protruding edge, having an end corresponding to said magnetic body, said end having a positioning slot, said tube-shape body being positioned with said magnetic body.

8. The structure defined in claim 6, wherein said connecting part of said magnetic body is an expanded slot, having an end corresponding to magnetic body, said end having a protruding edge, wherein space between said protruding edge and said connecting part of said magnetic body are connected by glue, said tube-shape body and said magnetic body being positioned with glue.

9. The structure defined in claim 6, wherein said block component is a tapered spring, said protruding block being formed by one end of an expanded tapered end, said elastic retractor being formed by a retracted tapered end.

10. The structure defined in claim 6, wherein said block component is comprised of an elastic C-shaped ring, said elastic C-shaped ring having an opening with a protruding section, said protruding block being formed by said protruding section, said elastic retractor being formed by the C-shaped ring.
